(19) United States
(12) Patent Application Publication
(10) Pub. No.: US 2020/0248704 A1
(43) Pub. Date: Aug. 6, 2020

(54) ELECTRIC MEDIA GAP MACHINE, AND COMPRESSOR AND/OR TURBINE

(71) Applicants: Robert Bosch GmbH, Stuttgart (DE); BMTS Technology GmbH & Co. KG, Stuttgart (DE)

(72) Inventors: Michael Bäuerle, Eberdingen (DE); Thomas Frühschütz, Holzkirchen (DE); Hartmut Weiss, Stuttgart (DE); Holger Rapp, Ditzingen (DE); Michael Nau, Dornhan/Aischfeld (DE); Peter Altermann, Stuttgart (DE); Ingo Immendoerfer, Tamm (DE)

(21) Appl. No.: 16/648,929

(22) PCT Filed: Sep. 18, 2018
(86) PCT No.: PCT/EP2018/075211

§ 371 Date: Mar. 19, 2020

(30) Foreign Application Priority Data
Sep. 22, 2017 (DE) 10 2017 216 858.7

(51) Int. Cl. F04D 25/06; H02K 5/128; H02K 9/06

(52) U.S. Cl. CPC F04D 25/0693; H02K 2005/1287; H02K 9/06; H02K 5/128

(57) ABSTRACT

The invention relates to an electric media gap machine (10) for a compressor (2) and/or a turbine (3), in particular for a turbocharger (1) of an internal combustion engine, comprising a shaft (5) which is rotatably mounted in a housing (6) and to which a rotor (11) is rotationally fixed, a stator (12) which is fixed to the housing and which has at least one multiphase drive coil (16) for generating a drive magnetic field and multiple stator teeth (15) which protrude inwards radially. The drive coil (16) is designed as at least one flat conductor coil (17) which is wound about the stator teeth (15) and which has coil heads (18, 19) projecting axially on both sides on the stator (12). The drive coil (16) has an end-face depression (21) on at least one of the coil heads (18, 19) for receiving a section of the housing (6) in at least some regions.

### BACKGROUND OF THE INVENTION

The invention relates to an electric media gap machine for a compressor and/or a turbine, in particular for an exhaust gas turbocharger of an internal combustion engine, having a shaft which is mounted rotatably in a housing and on which a rotor is arranged fixedly so as to rotate with it, having a stator which is fixed on the housing and has at least one multiphase drive winding for generating a drive magnetic field, and has a plurality of radially inwardly projecting stator teeth, the drive winding being configured as a flat conductor coil which is wound around the stator teeth and has winding heads which project on the stator axially on both sides.

Furthermore, the invention relates to a compressor and/or a turbine, in particular an exhaust gas turbocharger for an internal combustion engine, having a housing and having a shaft which is mounted rotatably in the housing and on which at least one compressor impeller or turbine wheel is arranged fixedly so as to rotate with it, and having an electric media gap machine which has a rotor, which is arranged fixedly on the shaft so as to rotate with it, and a stator which is fixed on the housing, the stator having a drive winding for generating a drive magnetic field.

Electric media gap machines and compressors or turbines or exhaust gas turbochargers of the type mentioned at the outset are already known from the prior art. Compressors, in particular turbochargers or exhaust gas turbochargers, are utilized, in particular, in automotive engineering to increase the air charge in cylinders of the internal combustion engine, in order to increase the power output of the internal combustion engine. To this end, exhaust gas turbochargers are frequently used which are driven by the exhaust gas flow of the internal combustion engine. Moreover, it is known to assist a turbocharger by electric motor, with the result that fresh air which is sucked in can be compressed and fed to the combustion engine at an increased boost pressure independently of an exhaust gas flow of the internal combustion engine. A turbocharger of this type has been proposed, for example, in laid open specification DE 10 2014 210 451 A1. A combination of the two variants is also already known. Here, an exhaust gas turbocharger is provided with an electric machine, in order to drive the shaft of the exhaust gas turbocharger, on which shaft a compressor impeller and a turbine wheel are arranged fixedly so as to rotate with it. As a result, for example, the boost pressure build-up can be accelerated significantly. Here, the electric machine is usually arranged on a side of the wheel, that is to say the compressor impeller or the turbine wheel, which side faces away from a bearing which mounts the shaft rotatably in the housing.

The realization of the electric motor assistance by way of a media gap machine has the advantage that the motorized assistance can be integrated into the turbocharger in a manner which particularly saves installation space, because the fresh air which is sucked in is guided through a media gap which is formed between the rotor and the stator of the media gap machine. Here, the media gap machine can be integrated into the flow course in a manner which saves installation space. Moreover, the advantage arises that the rotor and the stator of the media gap machine are cooled during operation by way of air flow.

The stator usually has a circularly annular stator yoke and stator teeth which project radially inward from the stator yoke and are arranged distributed such that they are spaced apart uniformly from one another as viewed in the circumferential direction. The stator teeth are usually wound around by a multiphase drive winding, a drive magnetic field which rotates and acts on the rotor which is likewise arranged fixedly on the shaft so as to rotate with it being generated by means of energization of the phases of the drive winding by means of power electronics provided for this purpose, by way of which drive magnetic field the rotor and the shaft are driven with a predefinable torque. Here, the rotor usually has one or more permanent magnets which interact with the rotating magnetic field.

### SUMMARY OF THE INVENTION

The media gap machine according to the invention having th has the advantage that the stator can be arranged in the housing in a particularly compact manner, and, in particular, can be guided axially particularly close to the impeller of the compressor or the turbine. According to the invention, it is provided to this end that, on at least one of the winding heads, the drive winding has an end-side depression for receiving a housing section of the housing at least in regions. As a result, the rotor of the media gap machine can also be arranged particularly close to the impeller in the housing, which has the advantage that the rotor moves axially closer to a bearing, in particular a plain bearing or a rolling body bearing, which mounts the shaft. The shaft of an exhaust gas turbocharger is usually mounted between the compressor impeller and the turbine wheel in the housing such that it can be rotated by way of a plurality of (shaft) bearings. The further away from the next bearing the rotor is arranged on the shaft, the higher the amplitudes of radial bending vibrations and bending moments which occur during running operation on account of unavoidable unbalances on the rotor, and which load the exhaust gas turbocharger and the media gap machine. The configuration according to the invention of the media gap machine therefore achieves a situation where the spacing from the impeller, that is to say, in particular, the compressor impeller, and therefore from the bearing is reduced or can be reduced and, as a result, the running behavior of the shaft and, in particular, of the rotor is improved.

In accordance with one preferred embodiment of the invention, the housing has a flow volute for gas flow management, and the depression is configured for receiving the flow volute at least in regions, in particular in the winding head which faces the compressor impeller. For optimum media flow management of the fresh air flow or exhaust gas flow through the compressor or the turbine, the housing has a flow volute as a housing section, as customary. Said flow volute usually protrudes in regions into the housing or into the interior space of the housing, in order to ensure an advantageous configuration which saves installation space. By virtue of the fact that the drive winding is configured for receiving the flow volute in regions, the drive winding can be arranged particularly close to the flow volute, and the stator can be arranged closer to the region of the flow volute as viewed axially, with the result that it lies in sections radially within the flow volute. As a result, the available installation space is utilized in an optimum manner and the abovementioned advantages are achieved.

Furthermore, it is preferably provided that the depression extends along the entire circumference of the winding head. As a result, the drive winding and therefore the stator overall can be displaced to a particularly great extent axially in the direction of the flow volute and therefore in the direction of the preferred rolling body bearing. The depression extends over the entire circumference of the winding head either in a continuously unchanged manner, or has a change in terms of its shape and/or design, in particular when the flow volute also changes its shape on its circumference, with the result that an optimum utilization of installation space and displacement of the stator in the direction of the flow volute or the bearing is ensured or made possible.

It is provided in accordance with one preferred development of the invention that the respective winding head has a radial height from an inner circumference as far as an outer circumference, and that the depression extends radially only over a region which is smaller than this height. Therefore, the depression does not extend over the entire end side, but rather only in regions at a radial height, with the result that a circumferential edge is cut out, for example, by way of the depression. In every case, a section of the winding head remains, which section extends axially as far as possible in the direction of the flow volute and, as a result, ensures the particularly close arrangement of the rotor to the next shaft bearing.

Furthermore, it is preferably provided that the depression extends as far as the outer circumference. Therefore, the drive winding is shorter axially on the outer circumference than on the inner circumference. The outer circumferential edge on the winding head is cut out by way of the depression, as a result of which the drive winding with the remaining projecting winding head can be pushed and is preferably pushed axially far into the flow volute.

Furthermore, it is preferably provided that the depression increases in the direction of the outer circumference. As a result, an optimum adaptation to the flow volute which is usually shaped with a circular or oval cross section is ensured.

The flat conductor coil preferably has a rectangular conductor cross section. This results in a maximum fill factor and a low electric resistance of the drive winding, and a current displacement effect at relatively high frequencies is lower in comparison with a wire with a round conductor cross section, which results overall in a very low power loss of the media gap machine.

In accordance with one preferred development of the invention, the media gap machine has an inner sleeve which surrounds the rotor completely on the circumferential side and axially at least in sections, and an outer sleeve which is arranged coaxially with respect to said inner sleeve, the drive winding being arranged radially outside the outer sleeve, and the flow path for the medium through the media gap machine being formed between the inner sleeve and the outer sleeve. The media gap machine therefore has a device which defines the flow path for the medium. Here, the flow path is delimited between the inner sleeve and the outer sleeve. The outer sleeve which has a greater diameter than the inner sleeve is configured, in particular, to support the drive winding and optionally the stator teeth, with the result that a particularly compact embodiment is made possible. In particular, the drive winding and optionally the stator teeth are fastened to the outer sleeve captively and, in particular, such that they can be dismantled only by way of destruction of the outer sleeve, with the result that a compact structure is provided. To this end, the outer sleeve has, for example, holding devices, in particular with latching devices, which ensure simple mounting and fixing of the drive winding and optionally the stator teeth on/to the outer sleeve.

The stator teeth or flux guiding elements of the stator teeth particularly preferably extend through the flow path as far as the inner sleeve or even penetrate the inner sleeve. Therefore, the stator teeth penetrate the flow path for the medium completely, and the flow path leads directly through the stator in the region of the stator teeth and not, as is customary in the case of previously known media machines, radially between the stator tooth tips and the rotor. As a result, a particularly compact embodiment is ensured which, moreover, has the advantage that the stator teeth and therefore the stator of the media gap machine are/is cooled by way of the medium which flows through the flow path.

The compressor according to the invention and/or the turbine according to the invention, in particular the exhaust gas turbocharger which has both the compressor and the turbine are/is distinguished by way of the media gap machine according to the invention. This results in the advantages which have already been mentioned. Further advantages and preferred features and combinations of features result, in particular, from the above-described text and from the claims.

### BRIEF DESCRIPTION OF THE DRAWINGS

In the following text, the invention is to be described in greater detail on the basis of the drawing, in which:

FIG. 1 shows an exhaust gas turbocharger having an integrated media gap machine in a simplified sectional illustration, and

FIG. 2 shows a cross-sectional illustration through the media gap machine.

### DETAILED DESCRIPTION

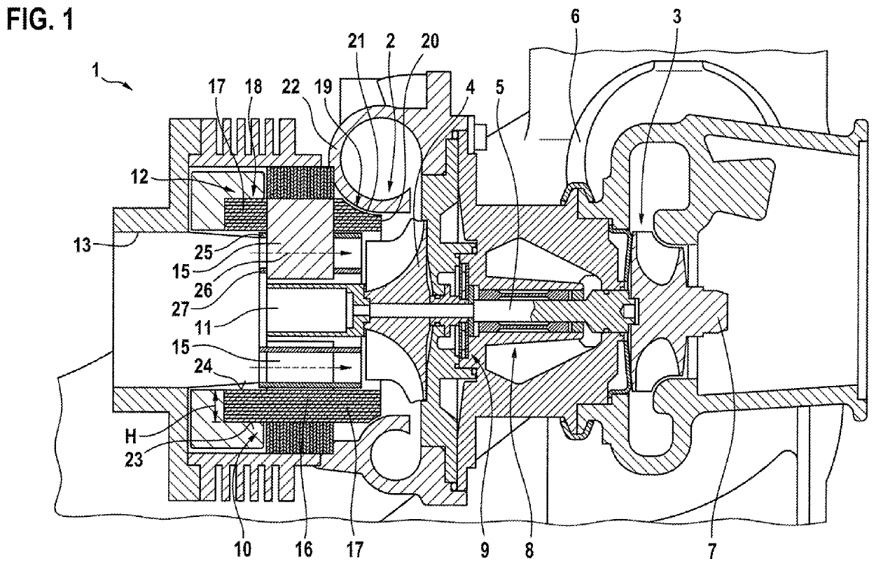

FIG. 1 shows a simplified longitudinal sectional illustration of an exhaust gas turbocharger 1 which has a compressor 2 and a turbine 3. The compressor 2 has a compressor impeller 4 which is arranged fixedly on a shaft 5 so as to rotate with it. The shaft 5 itself is mounted rotatably in a housing 6 of the exhaust gas turbocharger 1. At an end of the shaft 5 which faces away from the compressor impeller 4, moreover, a turbine wheel 7 of the turbine 3 is connected fixedly to the shaft 5 so as to rotate with it. When the turbine wheel 7 is flowed onto by the exhaust gas of an internal combustion engine and is driven as a result, the compressor impeller 4 is therefore likewise set in a rotational movement, with the result that fresh air which is fed to the compressor impeller 4 is compressed and is fed to the internal combustion engine.

The rotatable mounting of the shaft 5 in the housing 6 can be realized in different ways. It is provided in accordance with a first exemplary embodiment that the shaft 5 is mounted rotatably in the housing 6 by way of at least two bearings 8 and 9. There are preferably plain bearings as bearings 8, 9 both for axial and for radial mounting, as shown in FIG. 1. As an alternative, it can also be provided that at least one of the bearings is configured as a rolling body bearing.

As an alternative, it is provided in accordance with a further exemplary embodiment (not shown here) that at least the bearing 8 is configured as a magnetic bearing, and the bearing 9 which then serves, in particular, as an axial bearing is configured as a rolling body bearing.

In order that, in particular, the compressor 2 can be driven independently of the exhaust gas flow of the internal combustion engine, with the result that high cylinder air charging can be achieved at all times in the cylinders of the internal combustion engine, it is provided in the present case, moreover, that the exhaust gas turbocharger 1 has an electric media gap machine 10. In the present case, said media gap machine 10 is integrated into the compressor 2, a rotor 11 of the media gap machine 10 being arranged fixedly on that end of the shaft 5 which faces away from the turbine wheel 7, so as to rotate with said shaft 5. A stator 12 which interacts with the rotor 11 is arranged coaxially with respect to the rotor 11 in a manner which is fixed on the housing in that flow duct 13 of the exhaust gas turbocharger 1 which leads to the compressor impeller 4.

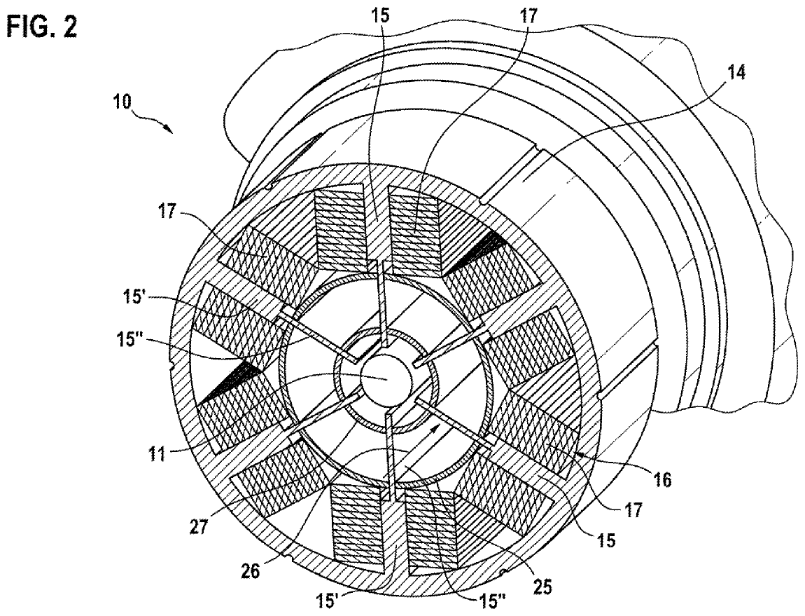

FIG. 2 shows a perspective sectional illustration of the media gap machine 10 for improved comprehension. The stator 12 has an annular, in particular circularly annular stator yoke 14, on which a plurality of stator teeth 15 which are arranged distributed uniformly over the circumference of the stator yoke 14 project radially toward the inside and point in the direction of the rotor 11 or the rotational axis of the shaft 5. The stator teeth 15 end in a manner which is spaced apart radially from the rotor 11, with the result that an air gap remains between the stator teeth 15 and the rotor 11. In the present case, the stator teeth have a base section 15′ which is assigned to the stator yoke 14 and a flux guiding element 15″ which extends the base section 15′ and the free end of which is assigned to the rotor 11.

The stator 12 is provided with a drive winding 16 which is, in particular, multiphase and is formed from a plurality of flat conductor coils 17 which are wound around the stator teeth 15. On the end sides of the stator 12, the flat conductor coils 17 in each case form a winding head 18 and 19 which protrudes axially beyond the stator teeth 15 and the stator yoke 14. Here, on its free end side 20, the winding head 19 which faces the compressor 2 has a depression 21 which is configured to receive a housing section of the housing 6 of the exhaust gas turbocharger 1.

In the present case, the compressor 2 has a flow volute 22, assigned to the impeller or compressor impeller 4. The flow volute 22 is formed by way of the housing 6 and protrudes axially beyond the compressor impeller 4 in the direction of the media gap machine 10, as shown in FIG. 1, in particular. The depression 21 of the winding head 19 is configured in such a way that it receives the flow volute 22 of the housing 6 at least in regions. To this end, the depression 21 is of curved configuration, as shown in the longitudinal section of FIG. 1, the curvature of the depression 21 being adapted to the curvature of the flow volute 22. Therefore, the shape of the depression 21 changes over the circumference of the winding head 19. Here, the depression 21 extends over a region of the winding head 19, which region is smaller than the height H between the outer circumference 23 and the inner circumference 24 of the drive winding 16. Here, the depression 21 is assigned to the outer circumference 23 in such a way that it cuts out an outer edge of the winding head 19.

The advantageous configuration and adaptation of the winding head 19 to the shape of the flow volute 22 achieves a situation where the drive winding 16 is fitted axially and, in particular, can be introduced in an optimum manner which saves installation space into the region between the flow volute 22 and the compressor impeller 4, with the result that the existing installation space can be utilized in an optimum manner and the exhaust gas turbocharger can be of axially shorter configuration. Moreover, this results in the advantage that the rotor 11 of the media gap machine 10 is likewise arranged closer to the compressor impeller 4. Here, the rotor 11 lies closer to the bearing 8, with the advantage that vibration or bending moments which act on the rotor 11 or are produced by way of the rotor 11 are reduced on account of the decreased spacing from the bearing 5, and, as a result, the smooth running of the exhaust gas turbocharger 1 is improved and its service life is extended. The flat conductor coils 17 are manufactured, in particular, by way of casting or by way of winding on edge. Whereas aluminum is preferably used as a material for the flat conductor coil in the case of casting for weight and cost reasons, copper tends to be suitable as a starting material for winding on edge for ductility reasons.

The depression 21 which forms the corresponding contour to the flow volute 22 is also produced directly during the casting process in the case of the cast flat conductor coil. In the case of the flat conductor coil which is wound on edge, a subsequent machining process, in particular a machining process with the removal of material, such as milling, for example, or reshaping is required. However, as a result of the use of a flat wire which is already insulated in the case of the wound on edge solution (enameled wire), a concluding insulation process is considerably simplified and less expensive in comparison with the cast variant. Moreover, the use of a rectangular conductor cross section of the flat conductor coil 17 results in a maximum fill factor and therefore a very low electric resistance. Moreover, a current displacement effect at relatively high frequencies is considerably lower in comparison with round winding wire, whereby a very low power loss is produced in the coil overall.

As shown in FIG. 2, the flat conductor coils 17 are advantageously arranged between the stator yoke 14 and an outer sleeve 25 which delimits a flow path 26 for the medium, in particular the fresh air, radially to the outside, which flow path 26 leads through the media gap machine 10. The outer sleeve 25 is penetrated by way of the stator teeth 15, in particular by way of their flux guiding elements 15″.

An inner sleeve 27 is arranged within the outer sleeve 25 coaxially with respect to the outer sleeve 25, which inner sleeve 27 is assigned to the rotor 11 but lies spaced apart from the latter. The stator teeth 15 extend with their flux guiding elements 15″ at least as far as the inner sleeve 27 or even penetrate the latter, with the result that they extend through the entire intermediate space between the outer sleeve 25 and the inner sleeve 27. The inner sleeve 27 delimits the flow path 26 radially towards the inside, and is preferably closed by way of a covering cap on its end side which lies upstream of the rotor 11, with the result that the medium which is guided through the media gap machine 10 is guided only through the flow path 26 between the inner sleeve 27 and the outer sleeve 25. Because the flow path 26 therefore leads through the stator 12 and the medium flows around the stator teeth 15, or at least the flux guiding elements 15″, the stator 12 and the rotor 11 are advantageously cooled by way of the medium. The outer sleeve 25 optionally has a corresponding number of stator teeth 15 and holding devices for holding and locking the flat conductor coils 17, with the result that the latter can be preassembled/are preassembled on the outer sleeve 25 and form a preassembled unit together with the outer sleeve 25. Moreover, the inner sleeve 27 is optionally connected to the outer sleeve 25, in particular is configured in one piece with the latter, in order to form a compact unit or preassembled group. Here, for example, radial webs are provided between the inner sleeve 27 and the outer sleeve 25, by way of which radial webs the single-piece configuration is ensured. The radial webs are configured, in particular, to receive in each case one of the flux guiding elements 15″ and to surround the latter, with the result that a compact and simple arrangement and orientation of the preassembled unit on the stator 12 is achieved.

1. An electric media gap machine (10) for a compressor (2) and/or a turbine (3), the media gap machine comprising
a housing,
a shaft (5) which is mounted rotatably in the housing (6) and on which a rotor (11) is arranged fixedly so as to rotate with the shaft,
a stator (12) which is fixed on the housing, which has at least one multiphase drive winding (16) for generating a drive magnetic field, and which has a plurality of radially inwardly projecting stator teeth (15), the drive winding (16) being configured as at least one flat conductor coil (17) which is wound around the stator teeth (15) and has winding heads (18, 19) which project on the stator (12) axially on both sides,
wherein, on at least one of the winding heads (18, 19), the drive winding (16) has an end-side depression (21) for receiving a housing section of the housing (6) at least in regions.

2. The media gap machine as claimed in claim 1, wherein the housing (6) has a flow volute (22) for gas flow management, and wherein the depression (21) is configured for receiving the flow volute (22) at least in regions.

3. The media gap machine as claimed in claim 1, wherein the depression (21) extends along an entire circumference of the winding head (19).

4. The media gap machine as claimed in claim 1, characterized in that each respective winding head has a radial height (H) from an inner circumference (24) as far as an outer circumference (23) of the drive winding (16), and in that the depression (21) extends radially only over a region which is smaller than the height (H).

5. The media gap machine as claimed in claim 4, characterized in that the depression (21) extends as far as into the outer circumference (23).

6. The media gap machine as claimed in claim 4, characterized in that the depression (21) increases in a direction of the outer circumference (23).

7. The media gap machine as claimed in claim 1, characterized in that each respective flat conductor coil (17) has a rectangular conductor cross section.

8. The media gap machine as claimed in claim 1, further comprising an inner sleeve (27) which surrounds the rotor (11) completely on a circumferential side and axially at least in sections, and an outer sleeve (25) which is arranged coaxially with respect to said inner sleeve (27), the drive winding (16) being arranged radially outside the outer sleeve (25), and a flow path (26) for medium through the media gap machine (10) being formed between the inner sleeve (27) and the outer sleeve (25).

9. The media gap machine as claimed in claim 8, characterized in that the stator teeth (15) or flux guiding elements (15″) of the stator teeth (15) extend through the flow path (26) as far at least as the inner sleeve (27).

10. The media gap machine as claimed in claim 9, characterized in that the stator teeth (15) or flux guiding elements (15″) of the stator teeth (15) penetrate the inner sleeve and protrude into the outer sleeve.

11. A compressor (2) and/or a turbine (3) having a housing (6) and having a shaft (5) which is mounted rotatably in the housing (6) and on which at least one compressor impeller (4) and/or one turbine wheel (7) are arranged fixedly so as to rotate with it, and having an electric media gap machine (10) which has a rotor (11), which is arranged fixedly on the shaft (5) so as to rotate with it, and a stator (12) which is fixed on the housing, the stator (12) having a drive winding (16) for generating a drive magnetic field, characterized by the configuration of the media gap machine (10) as claimed in claim 1.
